(19) United States
(12) Patent Application Publication
(10) Pub. No.: US 2025/0384317 A1
(43) Pub. Date: Dec. 18, 2025

(54) REGIONAL DECODERS FOR QUANTUM ERROR CORRECTION

(71) Applicant: International Business Machines Corporation, Armonk, NY (US)

(72) Inventors: Drew VANDETH, Essex Junction, VT (US); Blake Robert Johnson, Ossining, NY (US); Thomas Alexander, Halifax (CA); Antonio Corcoles-Gonzalez, Mount Kisco, NY (US); Ali Javadiabhari, Sleepy Hollow, NY (US); Lev Samuel Bishop, Dobbs Ferry, NY (US); Andrew Wack, Millbrook, NY (US)

(21) Appl. No.: 18/742,673

(22) Filed: Jun. 13, 2024

(51) Int. Cl. G06N 10/40; G06N 10/70

(52) U.S. Cl. CPC G06N 10/40; G06N 10/70

(57) ABSTRACT

One or more systems, devices, computer program products and/or computer-implemented methods of use provided herein relate to regional decoders for quantum error correction. Accordingly, a system can comprise a memory that can store computer executable components. The system can further comprise a processor that can execute at least one of the computer executable components that can map one or more regional decoders to one or more modules, wherein each of the one or more modules comprise one or more logical qubits, and wherein each of the one or more regional decoders operate on a region comprising one module and at least a subsection of another module. The at least one of the computer executable component can further coordinate activation of the one or more regional decoders by facilitating logical operations between a first logical qubit and a second logical qubit.

### BACKGROUND

The subject disclosure relates to quantum error correction and, more specifically, to regional decoders for quantum error correction.

A common problem in scaling quantum error correction to large systems is the input bandwidth and computational scaling of the decoder that converts a set of measured error syndromes into corrections that avoid logical errors. Most existing studies consider a “global” decoder that has access to all syndrome data and produces a correction relevant to the entire lattice of qubits. For a fixed physical error rate, this leads to an unbounded detection event input bandwidth that scales linearly with the number of qubits covered by the global decoder. The problem with computational scaling is worse because most decoding algorithms scale with at least a power law in the number of error syndromes. Thus, practical engineering limits in data bandwidth and computational power effectively upper bound the size of quantum error correction system that can be supported by a global decoder.

The invention described here partitions the decoding problem into a set of possibly overlapping regions. Each region has a size that is feasible to build given engineering considerations on bandwidth and computational power, removing the scaling limit of the decoding problem. This strategy is particularly applicable to quantum error correcting codes with a fixed size, such as bivariate bicycle codes, though the technique could be adapted to codes such as the surface code if the maximum size logical qubit were limited.

This regional decoding strategy must cover movement of logical qubits and logical multi-qubit gates. Therefore, the number of regions and region cover design must contemplate both memory operations as well as logical operations. It also comes at the cost of a coordination layer that synchronizes the decoding and control systems of the quantum computer. We deem this additional complexity as an acceptable cost to address scaling limitations of error corrected quantum computers.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable regional decoders for quantum error correction are discussed.

According to an embodiment, a system is provided. The system can comprise a memory that can store computer executable components. The system can further comprise a processor that can execute at least one of the computer executable components that can map one or more regional decoders to one or more modules, wherein each of the one or more modules comprise one or more logical qubits, and wherein each of the one or more regional decoders operate on a region comprising one module and at least a subsection of another module. The at least one of the computer executable component can further coordinate managing of the one or more regional decoders by facilitating logical operations between a first logical qubit and a second logical qubit.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate regional decoders for quantum error correction in accordance with one or more embodiments described herein.

FIG. 2 illustrates a block diagram of an example, non-limiting quantum system that can at least partially facilitate regional decoders for quantum error correction in accordance with one or more embodiments described herein.

FIG. 3 illustrates a block diagram of an example, non-limiting system of a qubit controller that can facilitate regional decoders for quantum error correction in accordance with one or more embodiments described herein.

FIG. 4 illustrates a block diagram of an example, non-limiting system of QEC controllers that can facilitate regional decoders for quantum error correction in accordance with one or more embodiments described herein.

FIG. 5 illustrates a diagram of example, non-limiting regional decoders mapped to modules representing a quantum system in accordance with one or more embodiments described herein.

FIG. 6 illustrates diagram of an example, non-limiting module of a quantum system in accordance with one or more embodiments described herein.

FIG. 7 illustrates diagram of example, non-limiting configurations of a regional decoder for modules in accordance with one or more embodiments described herein.

FIG. 8 illustrates diagram of example, non-limiting configurations of a regional decoder for modules in accordance with one or more embodiments described herein.

FIG. 9 illustrates diagram of example, non-limiting logical operations between qubits of modules via a regional decoder in accordance with one or more embodiments described herein.

FIG. 10 illustrates diagram of example, non-limiting logical operations between qubits of modules via a regional decoder in accordance with one or more embodiments described herein.

FIG. 11 illustrates a flow diagram of an example, non-limiting method that can facilitate regional decoders for quantum error correction in accordance with one or more embodiments described herein.

FIG. 12 illustrates a flow diagram of an example, non-limiting method that can facilitate regional decoders for quantum error correction in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute at least one of the computer executable components that can map one or more regional decoders to one or more modules, wherein each of the one or more modules comprise one or more logical qubits, and wherein each of the one or more regional decoders operate on a region comprising one module and at least a subsection of another module. The at least one of the computer executable component can further coordinate managing of the one or more regional decoders by facilitating logical operations between a first logical qubit and a second logical qubit.

Such embodiments of the system can provide a number of advantages, including limiting computation resource requirements for implementing decoders, increasing detection event input bandwidth of decoders, and improving scalability of a quantum system to comprise more physical qubits.

In one or more embodiments of the aforementioned system, the logical operations can comprise joining code of the first logical qubit to code of the second logical qubit if the first logical qubit and the second logical qubit are positioned within the same region operated on by a regional decoder. In one or more embodiments of the aforementioned system, the logical operations can further comprise teleporting the first logical qubit into the region operated on by the regional decoder comprising the second logical qubit and joining code of the first logical qubit to code of the second logical qubit. In one or more embodiments of the aforementioned system, the logical operations can further comprise teleporting the first logical qubit into the region operated on by the regional decoder comprising the first logical qubit and the second logical qubit.

Such embodiments of the system can provide a number of advantages, including reducing computation resource requirements for implementing decoders and improving scalability of a quantum system to comprise more physical qubits.

In one or more embodiments of the aforementioned system, the logical operations can be performed via lattice surgery, gauge fixing, code deformation, or code switching.

Such embodiments of the system can provide a number of advantages, including limiting computation resource requirements of decoders for quantum error correction.

In one or more embodiments of the aforementioned system, the one or more modules can be coupled together to form a graph topology of the quantum system, wherein the one module is adjacent to the other module in the graph topology.

Such embodiments of the system can provide a number of advantages, including limiting computation resource requirements of decoders for quantum error correction and improving detection event input bandwidths of the decoders.

In one or more embodiments of the aforementioned system, the at least one of the computer executable components can further obtain error syndromes of one or more physical qubits via respective qubit controllers, and wherein the one or more regional decoders transmit the error syndromes to respective quantum error correction (QEC) controllers.

Such embodiments of the system provide the advantage of increasing the scalability of quantum computers.

In one or more embodiments of the aforementioned system, a global QEC controller can distribute a QEC execution schedule to the respective QEC controllers, wherein the respective QEC controllers transmit the error syndromes to the global QEC controller.

Such embodiments of the system provide the advantage of increasing the scalability of quantum computers.

In one or more embodiments of the aforementioned system, the respective QEC controllers execute sub-schedules of a distributed QEC execution schedule that is shared between the respective QEC controllers, and wherein the respective QEC controllers transmit the error syndromes to other respective QEC controllers.

Such embodiments of the system provide the advantage of increasing the scalability of quantum computers.

In one or more embodiments of the aforementioned system, the one or more regional decoders can transmit logical frames to the respective qubit controllers.

Such embodiments of the system provide a number of advantages, including increasing the scalability of quantum computers and limiting computation resource requirements of decoders for quantum error correction.

In one or more embodiments of the aforementioned system, the respective QEC controllers can trigger the respective qubit controllers via sequence triggers.

Such embodiments of the system provide a number of advantages, including increasing the scalability of quantum computers and limiting computation resource requirements of decoders for quantum error correction.

In one or more embodiments of the aforementioned system, the logical operations can further comprise teleporting the first logical qubit or the second logical qubit to another subsection of a module operated on by a regional decoder.

Such embodiments of the system can provide a number of advantages, including limiting computation resource requirements of decoders for quantum error correction and improving scalability of a quantum system to comprise more physical qubits.

In an embodiment, the above described system can be employed to implement regional decoders in a quantum system for quantum error correction. Managing of the regional decoders can be coordinated to facilitate computation over the whole quantum system. Computation over the whole quantum system can be facilitated by the regional decoders operating on only a subset of the quantum system, wherein each of the regional decoders manages error correction for one or more logical qubits. For example, the regional decoders can operate on one or more modules of the quantum system, wherein the one or more modules comprise logical qubits that encode information in the physical qubits of the quantum system. This can bound computation of decoders and/or limit bandwidth required for detection event input, and therefore enable scalable quantum systems to comprise more qubits.

In the era of quantum utility, improving and enhancing quantum error correction abilities of quantum computers (or quantum processing units) are keys to unlocking the value of quantum computers. In this regard, enhancing the scalability and reliability of quantum systems can transform quantum computers into effective tools for scientific discovery and advancement. Quantum error correction (QEC) is pivotal for overcoming inherent fragility of quantum information processing systems caused by quantum decoherence and noise. However, decoders of contemporary QEC methods limit scalability of quantum systems as current decoders are computationally unbounded. Specifically, computational resources for decoding algorithms scale with at least a power law with respect to number of qubits that are covered. Further, for a fixed error rate, required detection event input bandwidth to a global decoder is unbounded, scaling linearly with the number of qubits covered in the quantum system. Therefore, for a given error rate, the number of detection events and/or the time required to solve the decoding problem will exceed the bandwidth or the time, memory, or compute resource budget permitted by the system design. That is, there is maximum size and time threshold for which a global decoder is not effective.

To overcome the problem of computational resource required, some existing approaches introduce multi-stage decoders that can decode some class of detection events in less time or using less computation. These multi-stage strategies decrease the average computational resource needed for decoding, but do not fundamentally alter the problem of unbounded computation because later stages of these multi-stage pipelines still need to handle the general global decoding problem. The various embodiments herein are directed to computationally bounding decoders for quantum error correction due to the general limitations of global decoders and quantum systems. Embodiments described herein include systems, computer-implemented methods, and computer program products that can reduce the amount of quantum resources employed in the implementation and execution of decoders by introducing techniques for limiting decoder sizes and facilitating computation across the quantum system through execution of logical operations. For example, in various embodiments, a system can detect an error in a qubit of the quantum system. Regional decoders can facilitate sequences of logical operations between logical qubits of different modules of the quantum system. For example, code of logical qubits can be teleported, code of logical qubits can be joined, or the logical qubits can be teleported. Overlapping regional decoder cover of a quantum system, as a result, can facilitate, using the logical operations, computation over the whole quantum system (e.g., transfers of encoded quantum information) without unbounded computation.

The various embodiments herein can computationally bound encoders by limiting decoder size to facilitate computation across a quantum system. Such improvements can reduce the cost of implementing decoders and extend the capabilities of quantum systems to comprise more qubits with significant increase in detection input bandwidth to the decoders.

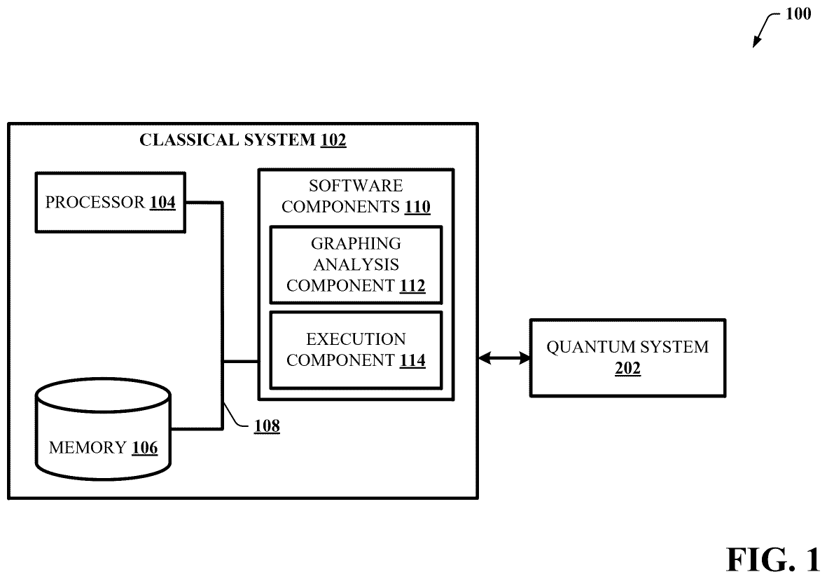

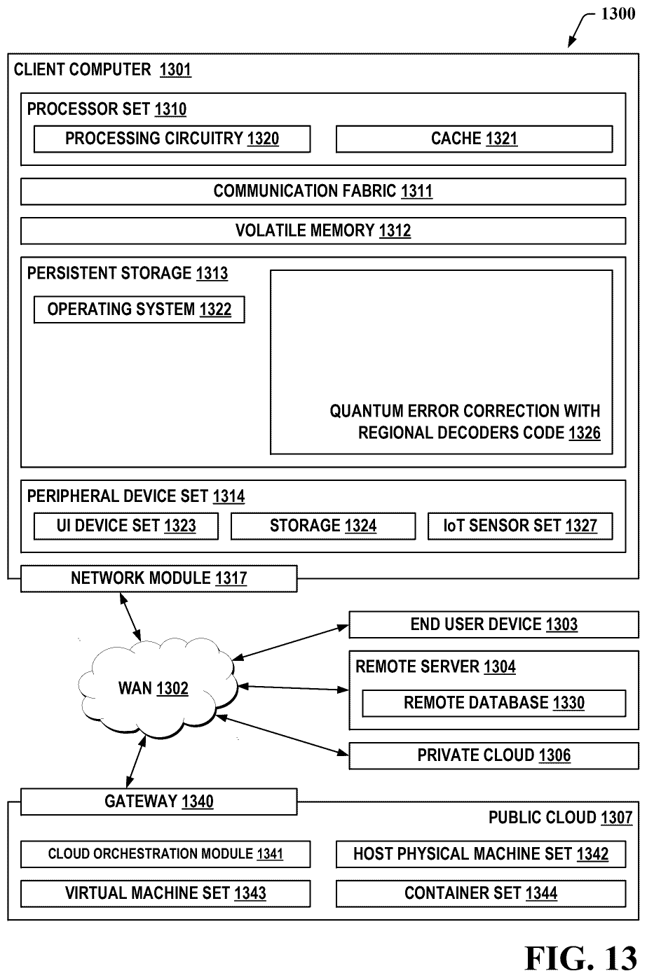

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated at FIG. 13. For example, non-limiting system 100 can be associated with, such as accessible via, a computing environment 1300 described below with reference to FIG. 13, such that aspects of processing can be distributed between non-limiting system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate regional decoders for quantum error correction in accordance with one or more embodiments described herein.

Non-limiting system 100 and/or the components of non-limiting system 100 can be employed to use hardware and/or software to solve problems that are highly technical in nature (e.g., related to quantum error correction, decoders, etc.), that are not abstract and that cannot be performed as a set of mental acts by a human. Further, some of the processes performed may be performed by specialized computers for carrying out defined tasks related to regional decoders for quantum error correction. Non-limiting system 100 and/or components of non-limiting system 100 can be employed to solve new problems that arise through advancements in technologies mentioned above and/or the like. Non-limiting system 100 can provide several technical improvements to quantum systems, including: limiting computation resource requirements for implementing decoders, increasing detection event input bandwidth of decoders, improving scalability of a quantum system to comprise more physical qubits, and enabling co-designing of control electronics with mapping of the regional decoders.

As illustrated in FIG. 1, non-limiting system 100 can comprise classical system 102 and quantum system 202. Classical system 102 can be coupled (operatively, communicatively, electrically, and/or like function) to quantum system 202. Classical system 102 can comprise one or more components, such as a memory 106, processor 104, bus 108, and/or software components 110. In an embodiment, software components 110 can be comprised at least partially by quantum system 202.

Discussion turns briefly to processor 104, memory 106 and bus 108 of non-limiting system 100. For example, in one or more embodiments, the non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., software components 110, graphing analysis component 112 and/or execution component 114) to perform one or more actions. In one or more embodiments, memory 106 can store computer-executable components (e.g., software components 110, graphing analysis component 112 and/or execution component 114).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

In various embodiments, classical system 102 can comprise software components 110 further comprising graphing analysis component 112 and execution component 114. Classical system 102 can be coupled (operatively, communicatively, electrically, and/or like function) to quantum system 202 to perform the operations described by the various embodiments herein. For example, in various embodiments, classical system 102 can be employed to facilitate quantum error correction in a quantum system. For instance, software components 110 can map regional decoders to modules representing the quantum system, and coordinate execution of the regional decoders on a quantum computer such as quantum system 202 by facilitating logical operations between logical qubits of different modules to cause the logical qubits to be positioned within a same regional decoder.

In various embodiments, graphing analysis component 112 can map one or more regional decoders to one or more modules. Each of the modules can comprise one or more physical qubits of the quantum system and implement one or more logical qubits. Further, the modules can comprise any suitable configuration. For example, the modules can comprise any suitable subsections or number of subsections (e.g., logical block, coupling lattice, probe ancilla). In an embodiment, each of the one or more regional decoders can operate on an entire module and at least a subsection of another module. For instance, a regional decoder can operate on an entire module and a coupling lattice of another module. As another example, a regional decoder can operate on an entire module and a logical block of another module. As yet another example, a regional decoder can operate on an entire module, and operate on a coupling lattice and a probe ancilla of another module. As still another example, a regional decoder can operate on an entirety of two modules, where the two modules are adjacent in the quantum system. As yet another example, a regional decoder can operate on more than two modules (e.g., operate on an entire module and a subsection of a second and third module, operate on two entire modules and a subsection of third module).

In another embodiment, execution component 114 can obtain error syndromes (e.g., a set of Pauli operators indicative of errors in the quantum state of a logical qubit that provide information to enable decoding) of the one or more physical qubits of the quantum system. In various embodiments, the error syndromes of the one or more physical qubits can be obtained via respective qubit controllers. More specifically, each of the one or more physical qubits can be interfaced with a qubit controller, where a syndrome measurement of each physical qubit can be obtained by the respective qubit controller. Accordingly, the qubit controllers can transmit the error syndromes to the one or more regional decoders. Thus, the one or more regional decoders can identify detection events between subsequent rounds of error syndrome collection.

In some embodiments, execution component 114 can coordinate managing of the one or more regional decoders by facilitating logical operations between a first logical qubit and a second logical qubit. The execution component 114 can facilitate this by combining the output of graph analysis component 112 (e.g., mappings of the regional decoders) with a quantum job request (e.g., the payload). Accordingly, the execution component 114 can generate or prepare a sequence of operations that is sent to control hardware (e.g., global QEC controller 204, QEC controllers 206) in quantum system 202 to facilitate the logical operations.

The various embodiments herein can enable the quantum system to comprise more qubits than current methods (e.g., global decoders) by constraining sizes of the one or more regional decoders, and thereby limiting computation resources needed for processing detection events over all qubits of the quantum system. In other words, the various embodiments herein can bound computation for decoders to enable scalability of qubits in quantum systems.

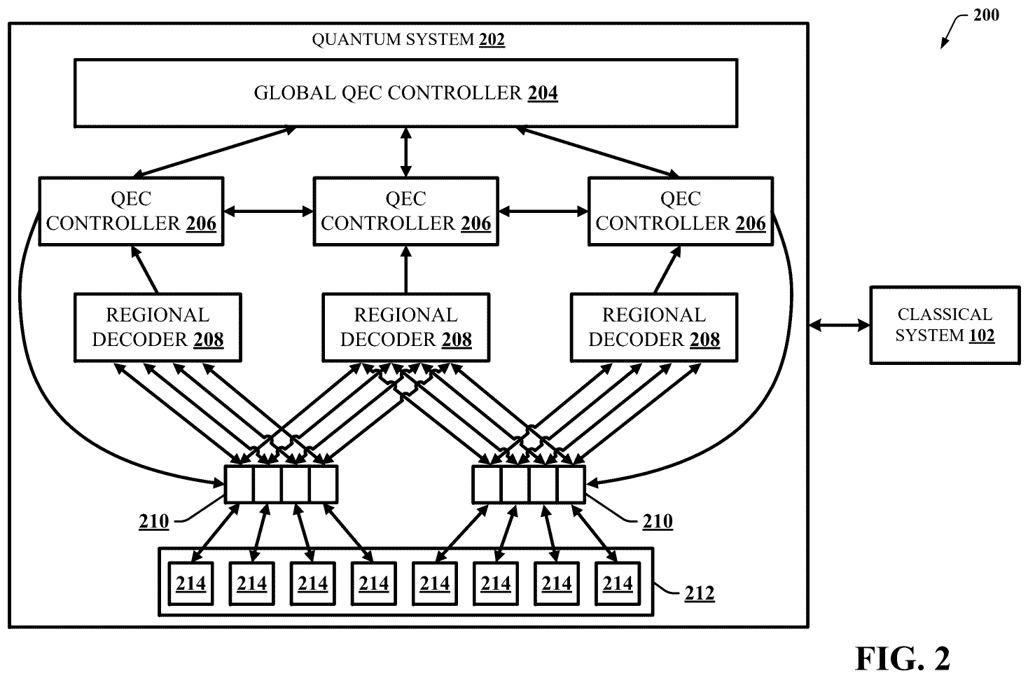

Turning to FIG. 2, one or more embodiments described herein can include one or more devices, systems and/or apparatuses that can provide a process to facilitate regional decoders for quantum error correction. Accordingly, at FIG. 2, illustrated is a block diagram of an example, non-limiting system 200 that can at least partially facilitate such a process. While referring here to one or more processes, facilitations and/or uses of the non-limiting system 200, description provided herein, both above and below, also can be relevant to one or more other non-limiting systems described herein, such as the non-limiting systems 100.

As illustrated at FIG. 2, the non-limiting system 200 can comprise a quantum system 202 that can be employed with or separate from the classical system 102.

Generally, the quantum system 202 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits) physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results (e.g., quantum measurement readout 320, from logical quantum measurement component 410) can be responsive to a quantum job request and associated input data and can be based at least in part on the input data, quantum functions and/or quantum computations.

In various embodiments, execution component 114 can coordinate managing of one or more of regional decoder 208 by facilitating logical operations between a first logical qubit and a second logical qubit via control hardware. In various aspects, such control hardware can comprise a global QEC controller 204. The global QEC controller 204 can be electronically coupled (e.g., communicatively, electrically, operatively, optically and/or like function) to one or more QEC controllers 206. In various instances, the global QEC controller can transmit a QEC execution schedule to the one or more QEC controllers 206. In some cases, the control hardware can comprise QEC controllers 206 without the global QEC controller 204. In such cases, the QEC controllers 206 can share a distributed QEC execution schedule, wherein each of the QEC controllers execute a sub-schedule (e.g., a portion of) the distributed QEC execution schedule. In such cases, the QEC controllers 206 can share a distributed QEC execution schedule, wherein each of the QEC controllers execute a sub-schedule (e.g., a portion of) the distributed QEC execution schedule. In any case, the one or more QEC controllers 206 can transmit sequence triggers to qubit controllers 210. A quantum chip 212 can comprise one or more, such as plural, qubits 214. Individual qubits of qubits 214, for example, can be fixed frequency and/or single junction qubits, such as transmon qubits. In various embodiments, the qubit controllers 210 can be coupled to the qubits 214 of the quantum system 202.

The sequence triggers can initiate measurements of quantum states of physical qubits 214, where the state of physical qubits 214 is read out to obtain classical information about the quantum system's state. In some instances, the sequence triggers can coordinate execution of error correction protocols based on detection of error syndromes by signaling the qubit controllers 210 to perform corrective operations to mitigate errors.

In various embodiments, the qubit controllers 210 can, in response to the sequence triggers from the one or more QEC controllers 206, obtain error syndromes of the physical qubits 214. Accordingly, the qubit controllers 210 can transmit the error syndromes to the one or more of regional decoder 208. The qubit controllers 210 can also transmit detection events to the regional decoders 208 (e.g., there is flexibility of converting error syndromes to detection events in the qubit controllers 210 or the regional decoders 208). Further, in some instances, the qubit controllers 210 can transmit soft data in the form of multi-bit measurement outcomes to the regional decoders 208. Thus, the one or more of regional decoder 208 can determine if a detection event has occurred in the physical qubits 214. Due to the configuration of regional decoder 208, wherein regional decoder 208 operates over at least one module, the qubit controllers 210 can be coupled to more than one of regional decoder 208. In some cases where regional decoder 208 operates over three modules, the qubit controllers 210 can be coupled to three of regional decoder 208. In any case, the one or more of regional decoder 208 can receive the error syndromes from the physical qubits 214 of different modules.

In various aspects, the one or more of regional decoder 208 can be coupled to the one or more QEC controllers 206. In some instances, each regional decoder 208 can be coupled to a respective QEC controllers 206. Accordingly, the one or more of regional decoder 208 can transmit the error syndromes (or Pauli frames, Clifford frames, or detection events) to the respective QEC controllers 206, and the respective QEC controllers 206 can transmit the error syndromes to the global QEC controller 204. In the case that the global QEC controller 204 is not implemented, the respective QEC controllers 206 can transmit the error syndromes to other respective QEC controllers 206. In the case that the global QEC controller 902 is not implemented, the respective QEC controllers 904 can transmit the error syndromes to other respective QEC controllers 904. In various cases, the global QEC controller 204 can generate the QEC execution schedule based on the error syndromes.

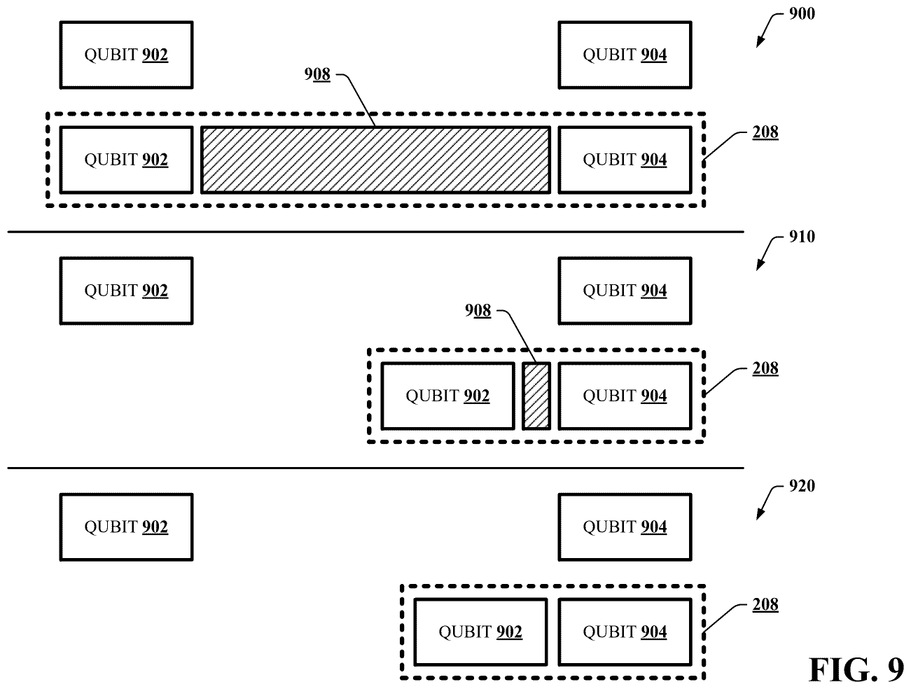

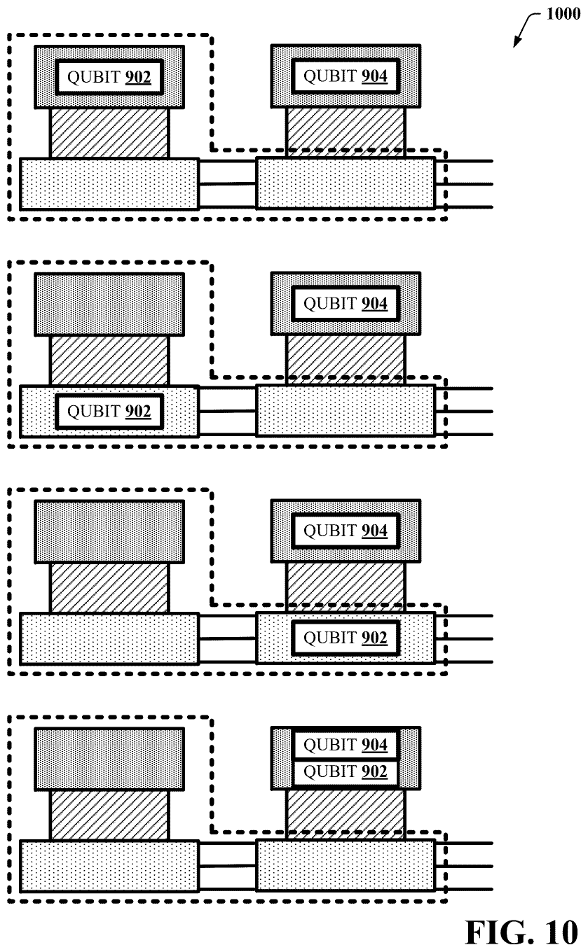

In various embodiments, in response to detecting, via the one or more of regional decoder 208, a detection event of the physical qubits 214, the one or more of regional decoder 208 can transmit logical frames (e.g., logical Clifford frames or Pauli frames) to the qubit controllers 210. More specifically, the one or more of regional decoder 208 can transmit quantum error correction instructions in response to a detection event. For instance, the quantum error correction instructions can comprise the logical operations described herein with respect to FIGS. 9 and 10.

In various aspects, the logical operations between the first logical qubit and the second logical qubit can comprise joining code sections (e.g., joining error correction code), teleporting a logical qubit, performing a logical operation between logical qubits, or performing a logical operation between a logical qubit and an ancilla probe system. For example, in cases when the first logical qubit and the second logical qubit are located within a same regional decoder (e.g., the first and second qubit are located in modules operated on by the same regional decoder), the QEC controllers 206 can join code of the first logical qubit with code of the second logical qubit. Joining code of logical qubits can involve combining or merging encoded quantum information from multiple logical qubits into a single quantum state or logical qubit. It can also involve extending the encoding of one or more logical qubits to a larger lattice of physical qubits. As another example, in cases when the first logical qubit is not located within the same regional decoder as the second logical qubit, the QEC controllers 206 can teleport the first logical qubit into an area operated on by the regional decoder that contains the second logical qubit. Teleporting qubits can involve entangling source and destination logical qubits through a series of controlled operations and measurements, followed by classical communication to convey the measurement outcomes, and thereby facilitate relocation of quantum states while preserving their encoded information. Therefore, after teleporting the first logical qubit, QEC controllers 206 can join codes of the first and second logical qubit. As yet another example, in instances when a regional decoder contains the first and second logical qubit, the QEC controllers 206 can teleport the first logical qubit into a module that contains the second logical qubit. Teleporting logical qubits can involve transferring a quantum state of one logical qubit to another without physically moving the qubits themselves. In any case, the logical operations can cause the first and second logical qubit to be positioned in modules operated on by the same regional decoder.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Such control hardware to coordinate managing of the one or more of regional decoder 208 can be implemented hierarchically to execute quantum error correction with achievable bandwidths for detection event input. In various embodiments, regional decoders, as described herein, can limit computation resources of decoders, improve scalability of quantum systems, enable such hierarchal building of control hardware with achievable bandwidths, and enable designability of control electronics in mapping the regional decoders to the quantum system.

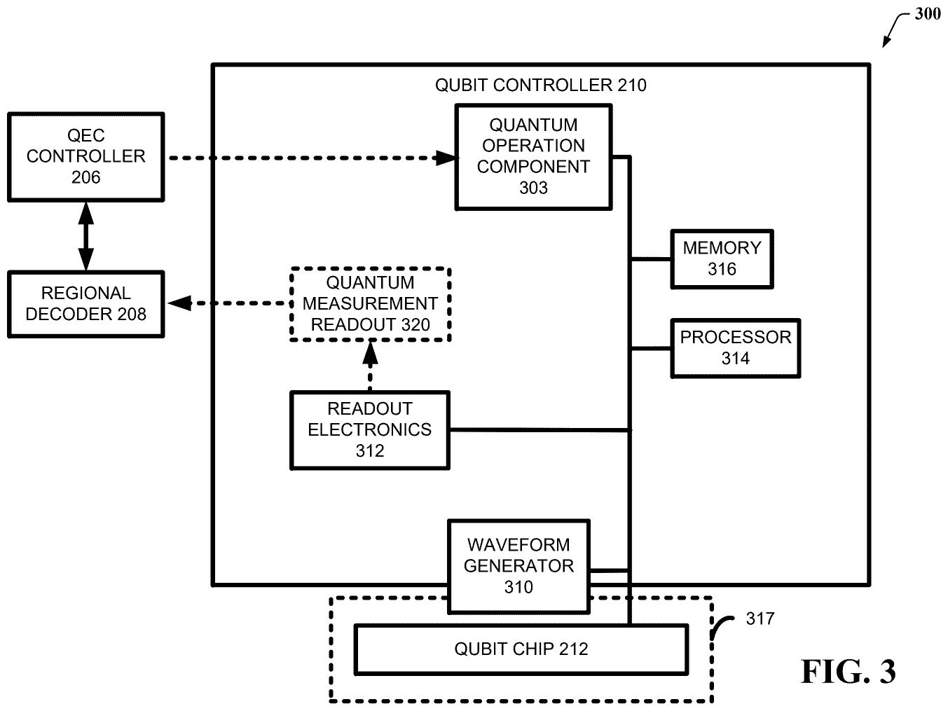

FIG. 3 illustrates a block diagram of an example, non-limiting system 300 of a qubit controller that can facilitate regional decoders for quantum error correction in accordance with one or more embodiments described herein.

In one or more embodiments, the qubit controller 210 can comprise components, such as a quantum operation component 303, pulse component 310 (e.g., a waveform generator) and/or a readout electronics 312 (e.g., readout component). In one or more other embodiments, the readout electronics 312 can be comprised at least partially by the classical system 102 and/or be external to the quantum system 202. In some instances, the whole of qubit controller 210 can be comprised at least partially by the classical system 102 and/or be external to the quantum system 202. Further, in some cases, the global QEC controller 204, the one or more QEC controllers 206, and/or the regional decoders 208 can be comprised at least partially by the classical system 102 and/or be external to the quantum system 202.

In one or more embodiments, a memory 316 and/or processor 314 can be associated with the quantum operation component 303, where suitable. The processor 314 can be any suitable processor. The processor 314 can generate one or more instructions for controlling the one or more processes of the quantum operation component 303.

The quantum operation component 303 can determine mapping of one or more quantum logic circuits for executing a quantum program. In one or more embodiments, the quantum operation component 303 and/or quantum chip 212 can direct the waveform generator 310 to generate one or more pulses, tones, waveforms and/or the like to affect one or more qubits 214.

The waveform generator 310 can generally cause the quantum chip 212 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 214 comprised by the quantum system 202.

The quantum chip 212 and a portion or all of the waveform generator 310 can be contained in a cryogenic environment, such as generated by a cryogenic environment 317, such as effected by a dilution refrigerator. Indeed, a signal can be generated by the waveform generator 310 to affect one or more of the plurality of qubits 214. Where the plurality of qubits 214 are superconducting qubits, cryogenic temperatures, such as about 4K or lower, can be employed for function of these physical qubits. Accordingly, one or more elements of the readout electronics 312 also can be constructed to perform at such cryogenic temperatures.

The readout electronics 312, or at least a portion thereof, can be contained in the cryogenic environment 317, such as for reading a state, frequency and/or other characteristic of qubit, excited, decaying or otherwise. The operation of the qubit controller 210 can allow for the output of quantum measurement readouts 320 associated with qubits 214.

The QEC controller 206 can provide a data stream of what operations to perform to the quantum operation component 303 that the qubit controller 210 can execute (e.g., indicate a sequence of operations, indicate a modification to previously stored sequences of operations). In other words, the QEC controller 206 can indicate the local implementation of the various techniques to facilitate the logical operations (e.g., lattice surgery, code deformation).

The quantum measurement readouts 320 can be passed directly to regional decoder 208. The measurement readouts 320 can comprise measurements or detection events related to qubits 214 that are connected to qubit controller 210. For instance, measurement readouts 320 can be soft data corresponding to a multi-bit response (e.g., any value in the interval 0 to 1), thresholded data (e.g., 0 or 1), or detection events (e.g., change of state) in measurement data.

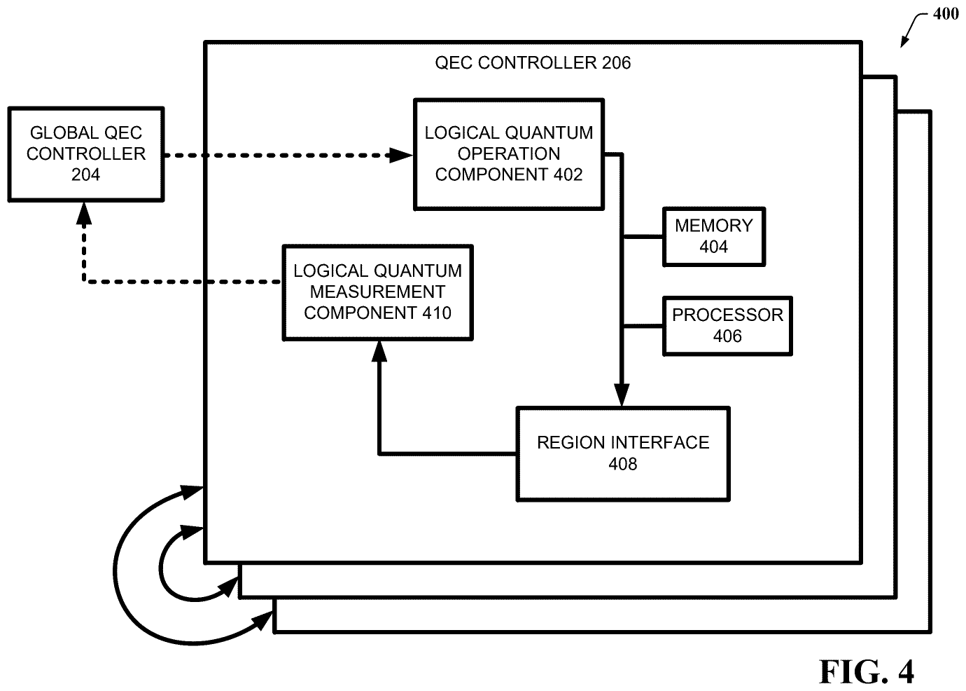

FIG. 4 illustrates a block diagram of an example, non-limiting system 400 of QEC controllers that can facilitate regional decoders for quantum error correction in accordance with one or more embodiments described herein.

In various embodiments, quantum system 202 can comprise one or more QEC controllers 206. In one or more embodiments, the QEC controllers 206 can comprise components, such as a logical quantum operation component 402, a region interface 408, and/or a logical quantum measurement component 410. In one or more other embodiments, the QEC controllers 206 (e.g., the logical measurement component 410) can be comprised at least partially by the classical system 102 and/or be external to the quantum system 202.

In one or more embodiments, a memory 404 and/or processor 406 can be associated with the logical quantum operation component 402, where suitable. The processor 406 can be any suitable processor. The processor 406 can generate one or more instructions for controlling the one or more processes of the logical quantum operation component 402.

In some embodiments, the one or more QEC controllers 206 can send or receive data from other QEC controllers 206. Such data can include, but is not limited to, Pauli frames, Clifford frames, error syndromes, or region control signals.

The logical quantum operation component 402 can receive data (e.g., the QEC execution schedule) from the global QEC controller 204 (e.g., or other QEC controllers 206). That is, the global QEC controller 204 can send localized sequences of a global sequence of logical operations to the logical quantum operation component 402 of each of the one or more QEC controllers 206. In various embodiments, the global QEC controller 204 can receive data from the logical quantum measurement component 410 (e.g., logical measurements).

In one or more embodiments, the region interface 408 can interface with the qubit controllers 210 and the regional decoders 208 to implement regional decoding within each of the qubit controllers 210 with region-specific syndrome sequences. Specifically, the region interface 408 can provide regional decoding configurations to the qubit controllers 210 (e.g., as a sequence of pulses, as an index value to a table) and error correction code selection information to the regional decoders 208 (e.g., as an index value to a table).

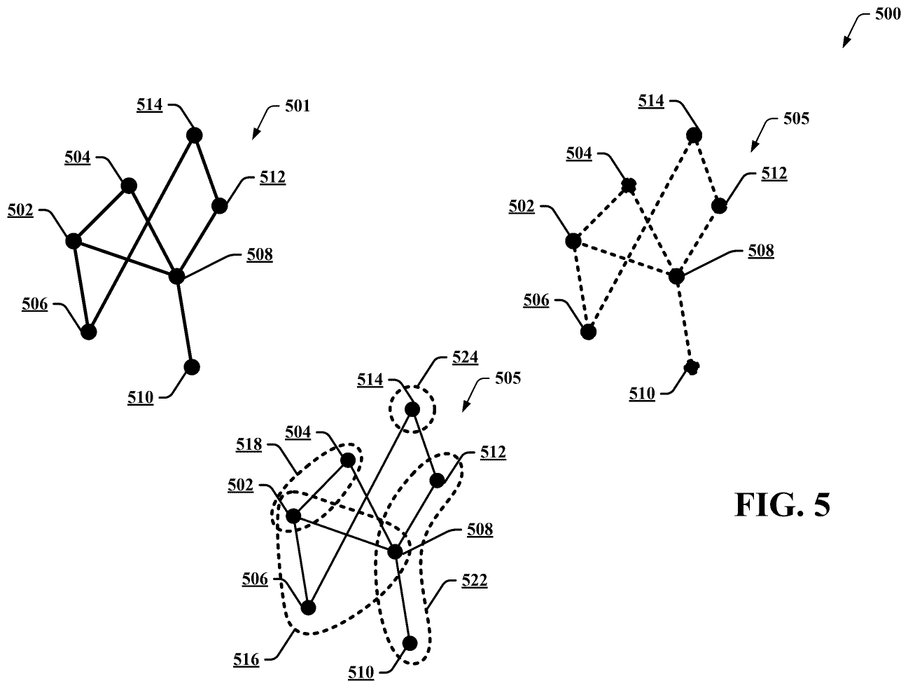

FIG. 5 illustrates diagram of example, non-limiting graphs 500 of regional decoders mapped to modules representing a quantum system in accordance with one or more embodiments described herein. Repetitive description of like elements and/or processes employed in respective embodiments is omitted for sake of brevity.

Graph 501 illustrates a module graph of connected modules that represent a quantum system. The quantum system can comprise any suitable number of modules. For instance, the quantum system represented in graph 501 comprises seven modules (e.g., module 602, module 504, module 506, module 508, module 510, module 512, module 514). In various aspects, the modules can be formed by one or more physical qubits that are tightly coupled together. In various embodiments, a module of the quantum system can be coupled to at least one other module of the quantum system. For example, as shown in graph 501, module 602 can be coupled to module 504, module 506, and module 508. Further depicted in graph 501, module 510 can be coupled to module 508. In various instances, however, the modules representing the quantum system can be coupled together in any suitable configuration (e.g., module 504 can be coupled to module 506).

Graph 503 illustrates a hypergraph decoder cover of regional decoders of the module graph representing the quantum system. In graph 503, regional decoders can operate on at least one module. For instance, as shown in graph 503, regional decoder 516 can operate on (e.g., cover) module 602, module 506, and module 508. Further depicted in graph 503, regional decoder 518 can operate on module 602 and module 504. Regional decoder 520 can operate on module 508, module 510, and module 512. Moreover, regional decoder 522 can operate on module 512 and module 514.

Graph 505 illustrates a graph decoder cover of regional decoders with a same topology as the module graph depicted in graph 501. In other words, the regional decoders can operate on subsets of the quantum system, wherein the regional decoders are mapped in such a way that enable computation over the entire quantum system.

By exploiting the implementation structure of regional decoders wherein each regional decoder operates on only a subset of the quantum system, the various embodiments herein can execute logical operations between logical qubits of different modules to facilitate computation over the entire quantum system. Doing so can reduce the computation resource requirements of decoders and thus enable scalability of the quantum system to comprise more physical qubits.

In the context of decoders in quantum error correction, current decoders can become less feasible as the number of qubits of the quantum system increases due to the current decoders being computationally unbounded (e.g., detection event input bandwidth requirement scales linearly with number of qubits it covers, computationally unbounded by scaling with at least a power law in terms of the number of qubits covered, for a given error rate, there is a size of the quantum system and time threshold for which a global decoder is not effective). On the contrary, the various embodiments herein can allow for quantum systems to scale to larger number of qubits with bounded computation requirements.

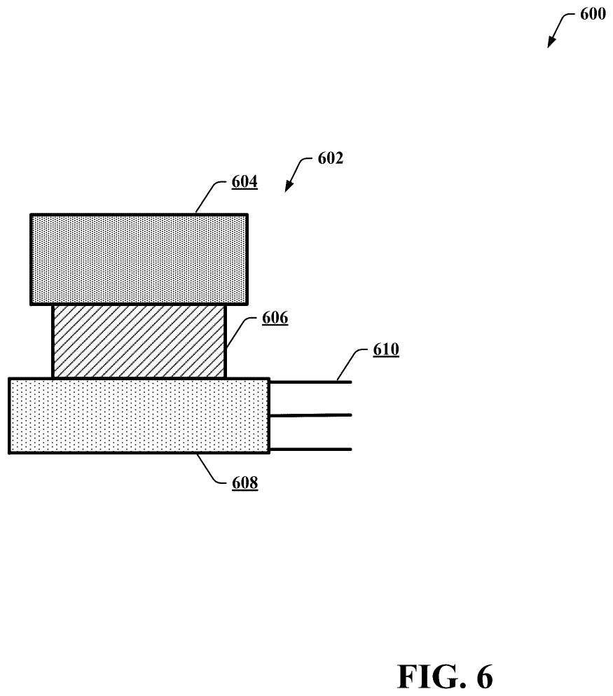

FIG. 6 illustrates an example, non-limiting diagram 600 of a module of a quantum system in accordance with one or more embodiments described herein. Repetitive description of like elements and/or processes employed in respective embodiments is omitted for sake of brevity.

Module 702 illustrates an example configuration of modules of the quantum system. As shown, module 702 can comprise three subsections. Specifically, the subsections of module 702 can be encoding areas. For example, module 702 can comprise a logical block 704, a probe ancilla 706, and a coupling lattice 708. In various cases, the module 702 can comprise any suitable number or type of encoding areas (e.g., error correction code stabilization region, quantum memory banks, ancilla preparation sites). In other words, the module 702 can comprise any suitable heterogenous configuration. For example, the module 702 can comprise only logical block 704 and probe ancilla 706. In various instances, the configuration of the module 702 can depend on the error correction code employed. For example, an error correction code can enable direct coupling between two or more of logical block 704. Accordingly, the module 702 can comprise only logical block 704.

A logical block is encoded quantum information or logical qubits that represent the physical qubits. In various embodiments, the logical block 704 can be encoded with any suitable error correction code (e.g., quantum Low Density Parity Check (qLDPC) codes, gross code, surface code) to construct the logical qubits. For example, qLDPC codes can be employed, which is a class of quantum error-correcting codes designed to protect quantum information against errors arising from noise and decoherence, and consists of a sparse bipartite graph structure where qubits and parity-check operators are represented as vertices and edges, respectively, allowing for efficient error correction by exploiting correlation between neighboring qubits and parity checks. As another example, the gross code is a specific instance of an qLDPC code, can be utilized to encode the quantum information into a lattice of physical qubits. In some instances, encoding quantum information into logical qubits can comprise applying a sequence of quantum gates to the physical qubits according to the error correction code. Further, the error correction code can be applied to redundantly encode the quantum information across multiple physical qubits to enable detection and correction of error during quantum computation. Specifically, in response to detection of an error via error syndrome extraction, error correction operations can be applied to the physical qubits to restore the encoded quantum information of the physical qubit to its original state. In some cases, the error may simply be tracked and the error information used to interpret the outcome of logical measurements.

A probe ancilla is additional qubits (e.g., auxiliary qubits, ancilla qubits) that can allow manipulation of the logical qubits that are encoded in one or more logical blocks. In various aspects, the probe ancilla 706 can comprise physical ancilla qubits or logical ancilla qubits. By entangling or interacting with physical qubits in the logical block 704, the probe ancilla 706 can facilitate various operations such as measurements, error correction, or entanglement generation within the quantum system.

A coupling lattice is a network of interconnected physical qubits that defines a spatial arrangement and connectivity of the physical qubits. In various embodiments, the coupling lattice can facilitate logical operations between modules. In various cases, the coupling lattice 408 can also comprise error correction code (e.g., qLDPC codes, gross code, surface code).

In various embodiments, the module 702 can comprise an inter-module coupler 710. In various aspects, the inter-module coupler 710 can facilitate interaction between modules. Specifically, the modules can be communicatively, electrically, operatively, optically and/or otherwise coupled to one another via the inter-module coupler 710. For instance, inter-module coupler 710 can facilitate such interaction between modules via quantum buses, mediated interactions, entanglement swapping, or remote gate operations. In some cases, module 702 can comprise more than one inter-module coupler to facilitate interaction between module 702 and two or more other modules.

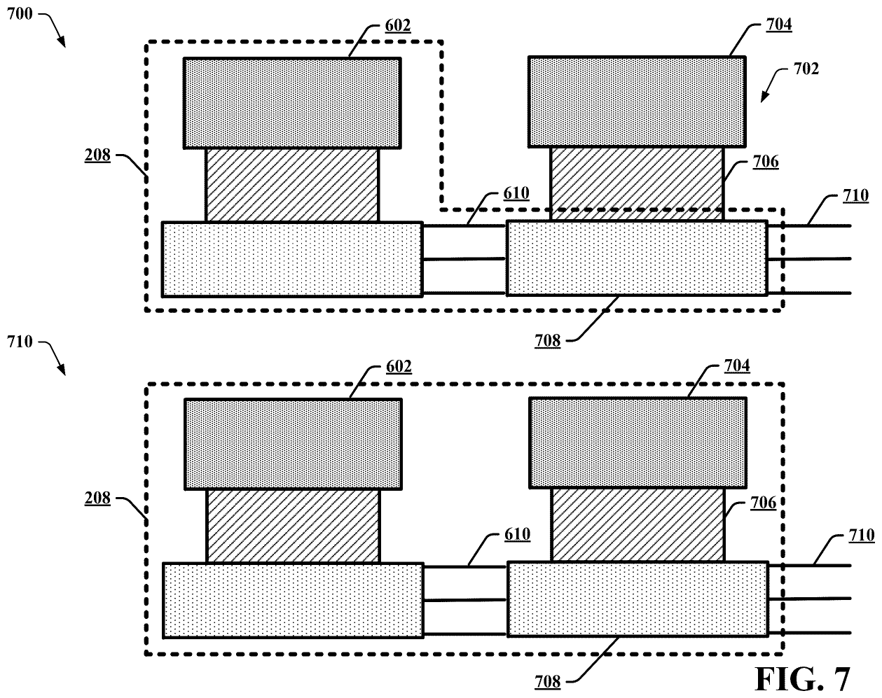

FIG. 7 illustrates diagram of example, non-limiting configurations 700 and 710 of a regional decoder for modules in accordance with one or more embodiments described herein. Repetitive description of like elements and/or processes employed in respective embodiments is omitted for sake of brevity.

In various embodiments, there can be a module 702. The module 702 can comprise a same structure and configuration as module 602. For example, module 702 can comprise logical block 704, probe ancilla 706, coupling lattice 708, and inter-module coupler 710. In various aspects, module 602 and module 702 can be coupled together via inter-module coupler 610. In various embodiments, a regional decoder 208 can comprise non-limiting configurations 700 and 710, wherein the regional decoder 208 operates over all encoding areas of a first module and at least one encoding area of a second module.

As a non-limiting example, configuration 700 can consist of regional decoder 208 operating over module 602 and a subsection of module 702. Specifically, regional decoder 208 can operate over logical block 604, probe ancilla 606, and coupling lattice 608 of module 602, and over coupling lattice 708 of module 702.

As another non-limiting example, configuration 710 can consist of regional decoder 208 operating over all encoding areas of module 602 and all encoding areas of module 702. Specifically, regional decoder 208 can operate over logical block 604, probe ancilla 606, and coupling lattice 608 of module 602, and over logical block 704, probe ancilla 706, and coupling lattice 708 of module 702.

Note that, non-limiting configurations 700 and 710 are mere non-limiting examples and regional decoder 208 can comprise any suitable configuration such that regional decoder 208 operates over all encoding areas of a first module and at least one encoding area of a second module. For instance, regional decoder 208 can operate over more than two modules (e.g., over all encoding areas of a first module and a coupling lattice of second and third module, over all encoding areas of four modules). In some cases, regional decoder 208 can operate over a different encoding area of the second module (e.g., over all encoding areas of a first module and a logical block of a second module, over all encoding areas of a first and second module and a logical block of a third module). In instances when the regional decoder 208 operate over more than two modules, the regional decoder 208 can operate over different encoding areas of the modules (e.g., over all encoding areas of a first module, a logical block of a second module, and a coupling lattice of a third module). In any case, graphing analysis component 112 can regional decoder 208 to modules of the quantum system.

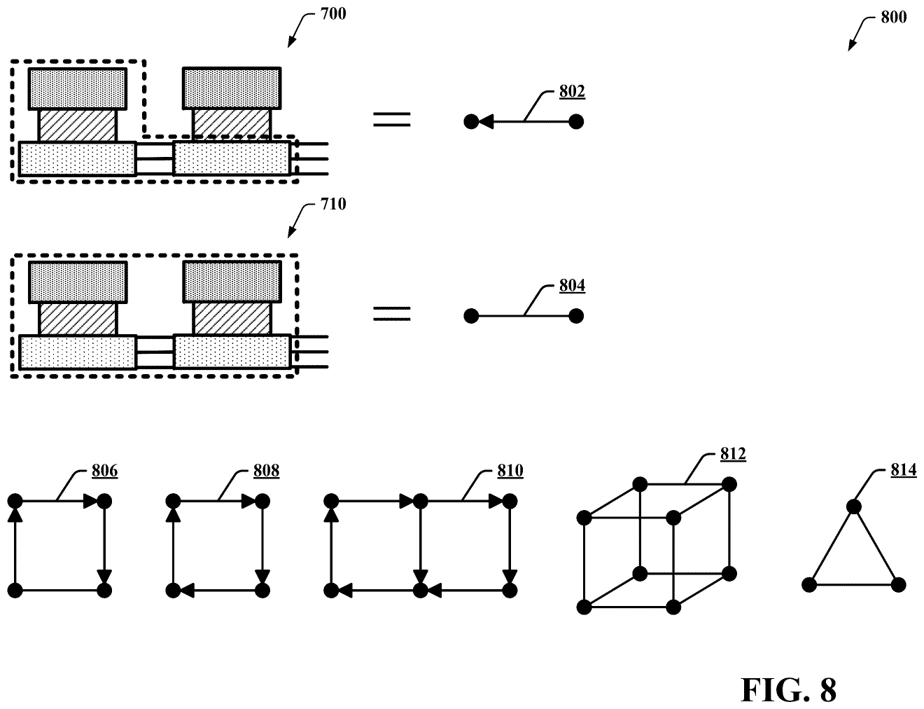

FIG. 8 illustrates an example, non-limiting diagram 800 of configurations of a regional decoder for modules in accordance with one or more embodiments described herein. Repetitive description of like elements and/or processes employed in respective embodiments is omitted for sake of brevity.

In various embodiments, regional decoder 208 can be extended to a graph of modules. That is, the graphing analysis component 112 can map more than one of regional decoder 208 to modules of the quantum system such that computation can be facilitated over the entire quantum system. Mapping arrangements (e.g., tiling) of more than one of regional decoder 208 can be dependent on connectivity of the modules. For example, the mapping arrangements of more than one of regional decoder 208 can be based on connectivity constraints of the modules, such as modularity or regularity. In any case, the modules can be connected in any suitable configuration. For instance, configuration of the modules can be linear.

As a non-limiting example, configuration 700 of regional decoder 208 (e.g., regional decoder 208 operates over all encoding areas of module 602 and coupling lattice 708 of module 702) can facilitate one-directional connectivity between linearly connected modules, and more specifically from module 702 to module 602, as illustrated by module graph 802. As another non-limiting example, configuration 710 of regional decoder 208 (e.g., regional decoder 208 operates over all encoding areas of module 602 and module 702) can facilitate bidirectional connectivity between module 602 and module 702 when linearly connected, as illustrated by module graph 804. In either case, regional decoder 208 can facilitate execution of logical operations between logical qubits of module 602 and module 702 to cause the logical qubits to be positioned within a same regional decoder (e.g., regional decoder 208). That is, for configuration 700, regional decoder 208 can facilitate execution of logical operations to cause the logical qubits of module 602 and module 702 to be positioned within module 602. For configuration 710, regional decoder 208 can facilitate execution of logical operations to cause the logical qubits of module 602 and module 702 to be positioned within module 602, or to cause the logical qubits of module 602 and module 702 to be positioned within module 702.

In other cases, configuration of the modules can comprise a two-dimensional arrangement. An example non-limiting two-dimensional configuration of the modules is illustrated by module graph 806. In various embodiments, each of the more than one of regional decoder 208 can comprise different configurations. For example, in module graph 806, a first regional decoder can operate over all encoding regions of module 602 and module 702 and a second regional decoder can operate over all encoding regions of module 602 and coupling lattice 708 of module 702. Another example non-limiting two-dimensional configuration of the modules is illustrated by module graph 808. In various embodiments, graphing analysis component 112 can map four of the regional decoder 208 to facilitate connectivity between four modules to form module graph 808, wherein each of the four of the regional decoder 208 comprises configuration 700. In various aspects, the graphing analysis component 112 can optimally or non-optimally map the more than one of regional decoder 208 to the modules. Such mapping of the four of the regional decoder 208 in module graph 808 can be considered an optimal mapping. That is, such mapping can facilitate computation over all the modules with a minimal number and size of regional decoders. Conversely, a non-optimal mapping of more than one of regional decoder 208 onto the modules can be depicted by module graph 810. Such mapping can be considered non-optimal because less regional decoders than those depicted in module graph 810 can be implemented to facilitate computation over all the modules. Yet another non-limiting example of mapping of more than one of regional decoder 208 to two-dimensionally connected modules is illustrated by module graph 814. Module graph 814 depicts a mapping of the more than one of regional decoder 208 to modules connected in a triangular configuration, wherein each of the more than one of regional decoder 208 mapped to the modules comprises configuration 710.

In still other cases, configuration of the modules can comprise a three-dimensional arrangement. An example non-limiting three-dimensional configuration of the modules is illustrated by module graph 812. Module graph 812 depicts a mapping of the more than one of regional decoder 208 to the modules, wherein each of the more than one of regional decoder 208 mapped to the modules comprises configuration 710. Note that, although the non-limiting aspects described herein discuss the regional decoder 208 to comprise either configuration 700 or configuration 710, any suitable configuration of the regional decoder 208 can facilitate computation over the modules. For instance, module graph 812 can be achieved with regional decoders that operate over more than two modules (e.g., regional decoder that operates on all encoding areas of three connected modules).

FIG. 9 illustrates diagram example, non-limiting logical operations 900, 910, and 920 between logical qubits of modules via a regional decoder in accordance with one or more embodiments described herein. Repetitive description of like elements and/or processes employed in respective embodiments is omitted for sake of brevity.

In various embodiments, the execution component 114 can coordinate managing of the one or more of regional decoder 208 by facilitating logical operations between a first logical qubit and a second logical qubit. The first logical qubit and the second logical qubit can be in different modules. For instance, the logical operations can comprise non-limiting logical operations 900, 910, and 920. In various aspects, non-limiting logical operations 900 can comprise joining code 908 of a logical qubit 902 with code of a logical qubit 904, wherein logical qubit 902 is in a different module than logical qubit 904. To facilitate joining of codes between logical qubit 902 and logical qubit 904, logical qubit 902 and logical qubit 904 can be positioned within a same regional decoder. For example, regional decoder 208 can operate on both modules in which the logical qubit 902 and logical qubit 904 are located in.

In various embodiments, non-limiting logical operations 910 can comprise teleporting code 908 of logical qubit 902 to a region that is covered by regional decoder 208 containing logical qubit 904, wherein logical qubit 902 is in a different module than logical qubit 904. In various aspects, the code 908 can be teleported to the module comprising logical qubit 904. Therefore, the execution component 114 can join code 908 of logical qubit 902 with code of a logical qubit 904.

In various instances, non-limiting logical operations 920 can comprise teleporting logical qubit 902 to a region that is covered by regional decoder 208 containing logical qubit 904, wherein logical qubit 902 is in a different module than logical qubit 904. In any case of which logical operation is executed, the execution component 114 can coordinate managing of the one or more of regional decoder 208 to facilitate such logical operations to enable logical qubit 902 and logical qubit 904 to be positioned within a same regional decoder.

In various embodiments, the execution component 114 can facilitate the logical operations to be performed on multiple logical qubits in parallel. The logical operations (e.g., non-limiting logical operations 900, 910, and 920) can be executed via any suitable method or technique. For example, the method or technique employed can depend on which quantum error correction code is utilized (e.g., gross code, surface code), available connectivity of the modules of the quantum system, or the mapping configuration of the regional decoders on the modules. As an example, the logical operations can be facilitated via, but is not limited to, lattice surgery (e.g., quantum error correction technique where physical qubits are arranged in a lattice structure, facilitating the implementation of logical operations between logical qubits by performing controlled operations and measurements across neighboring physical qubits), gauge fixing (e.g., a process of selecting a particular representation of a quantum state, often to simplify calculations or perform logical operations between logical qubits by setting specific conditions on the gauge fields, to enable manipulation of logical qubits), code deformation (e.g., process of modifying the structure or parameters of an error-correcting code to adapt it to specific error characteristics or constraints), or code switching (e.g., method in error correction where different error-correcting codes are employed interchangeably based on the prevailing error conditions or operational requirements).

FIG. 10 illustrates diagram of example, non-limiting logical operations 1000 between qubits of modules via a regional decoder in accordance with one or more embodiments described herein. Repetitive description of like elements and/or processes employed in respective embodiments is omitted for sake of brevity.

In various embodiments, the execution component 114 can coordinate managing of the one or more of regional decoder 208 to facilitate a sequence of logical operations between a first logical qubit and a second logical qubit. For instance, the one or more of regional decoder 208 can facilitate an example sequence of non-limiting logical operations 1000 between logical qubit 902 and logical qubit 904. As illustrated in FIG. 10, regional decoder 208 can comprise configuration 700. Further, logical qubit 902 and logical qubit 904 are comprised in different modules that are coupled together. In various aspects, the sequence of logical operations can comprise teleporting logical qubit 902 from logical block 604 to coupling lattice 608 of the module. More specifically, the logical qubit 902 can be teleported from the Gross code of logical block 604 to the Surface code in coupling lattice 608. To facilitate this logical operation, a regional decoder must operate over all encoding areas of the module. In various embodiments, the sequence of logical operations can then comprise moving the logical qubit 902 to the coupling lattice 708 of the adjacent module. The logical qubit 902 can be moved, for example, via gauge fixing or lattice surgery. To facilitate this logical operation, a regional decoder must operate over coupling lattices of both modules (e.g., coupling lattice 608 and coupling lattice 708). In various embodiments, the sequence of logical operations can further comprise teleporting the logical qubit 902 into logical block 704 of the adjacent module. Specifically, the logical qubit 902 can be teleported into the target Gross code in logical block 704 of the adjacent module. To facilitate this logical operation, a regional decoder must operate over all encoding areas of the adjacent module. A second regional decoder can facilitate this logical operation as regional decoder 208 does not operate over all encoding areas of the adjacent module.

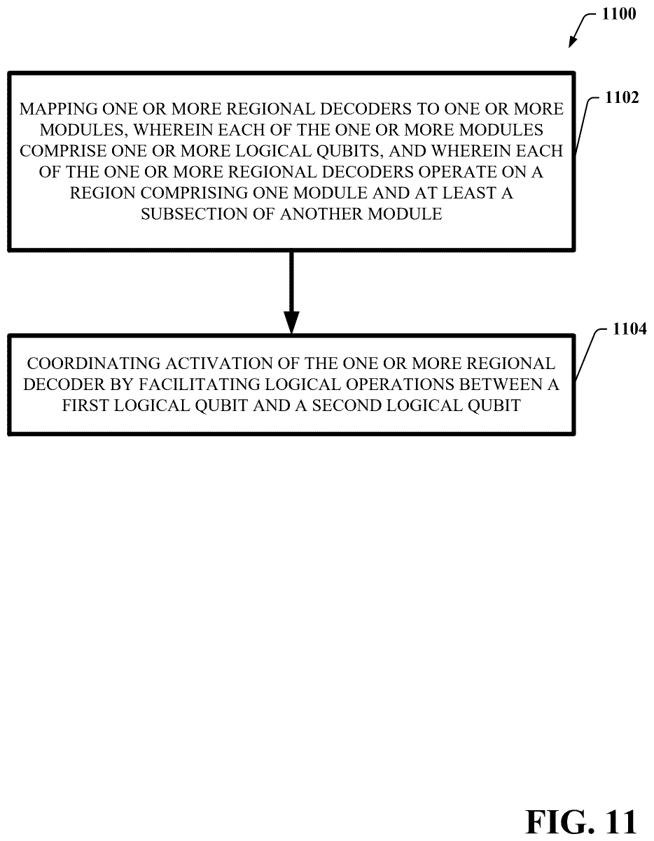

FIG. 11 illustrates a flow diagram of an example, non-limiting method 1100 that can facilitate regional decoders for quantum error correction in accordance with one or more embodiments described herein. Repetitive description of like elements and/or processes employed in respective embodiments is omitted for sake of brevity.

The embodiments of the present disclosure can result in execution of regional decoders over a quantum system, which can reduce computation resource requirements to implement the regional decoder, and thereby enable saleability of the quantum system to comprise more qubits. Non-limiting method 1100 illustrates the steps involved in the process at a high level.

At step 1102, non-limiting method 1100 can comprise mapping (e.g., by graphing analysis component 112), by a system operatively coupled to a processor, one or more regional decoders to one or more modules, wherein each of the modules comprise one or more logical qubits, and wherein each of the one or more regional decoders operate on a region comprising one module and at least a subsection of another module.

At step 1104, non-limiting method 1100 can comprise coordinating (e.g., by execution component 114, by global QEC controller 204), by the system, managing of the one or more regional decoders by facilitating logical operations between a first logical qubit and a second logical qubit. As described with respect to FIGS. 9 and 10, the logical operations can comprise joining codes of logical qubits within a same regional decoder, teleporting a logical qubit into a region of a regional decoder, or teleporting a logical qubit into a region of a regional decoder. The logical operations can be facilitated via the regional decoders to cause logical qubits of different modules to be positioned within a same regional decoder. Thus, the regional decoders can facilitate computation across all modules of the quantum system.

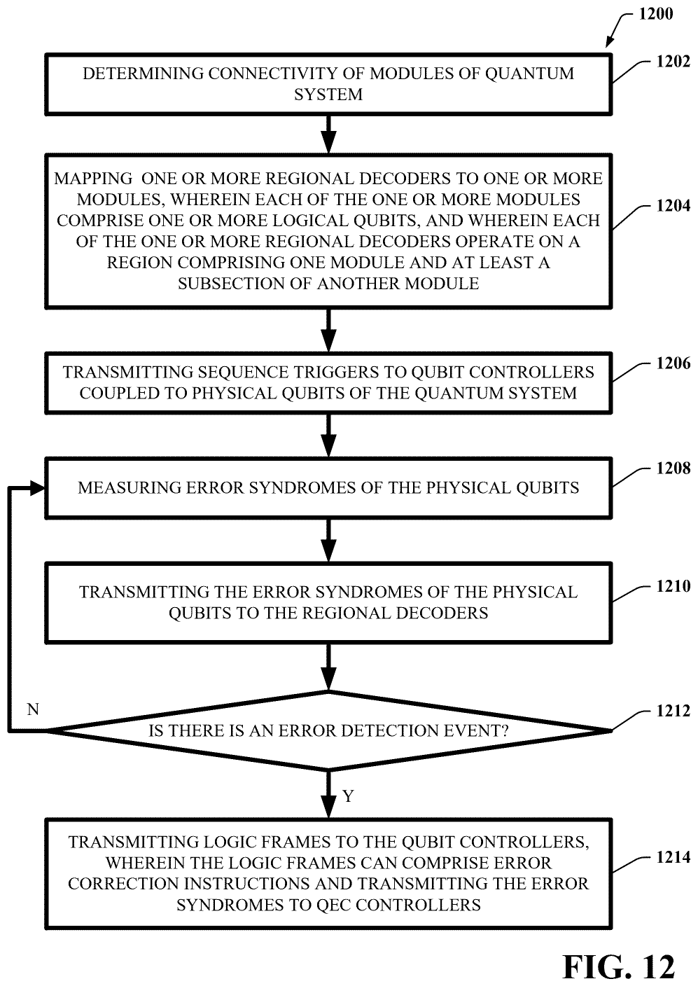

FIG. 12 illustrates a flow diagram of an example, non-limiting method 1200 that can facilitate regional decoders for quantum error correction in accordance with one or more embodiments described herein. Repetitive description of like elements and/or processes employed in respective embodiments is omitted for sake of brevity.

At step 1202, non-limiting method 1200 can comprise determining (e.g., by graphing analysis component 112), by a system operatively coupled to a processor, connectivity of modules of quantum system.

At step 1204, non-limiting method 1200 can comprise mapping (e.g., by graphing analysis component 112), by the system, one or more regional decoders to one or more modules, wherein each of the modules comprise one or more logical qubits, and wherein each of the one or more regional decoders operate on a region comprising one module and at least a subsection of another module.

At step 1206, non-limiting method 1200 can comprise transmitting (e.g., by execution component 114), by the system, sequence triggers to qubit controllers coupled to physical qubits of the quantum system. In various aspects, the sequence triggers can signal the qubit controllers to obtain control or readout signals from the physical qubits.

At step 1208, non-limiting method 1200 can comprise measuring (e.g., by execution component 114), by the system, error syndromes of the physical qubits. In various embodiments, the error syndromes can be measured by the qubit controllers.

At step 1210, non-limiting method 1200 can comprise transmitting (e.g., by execution component 114), by the system, the error syndromes of the physical qubits to the regional decoders. In various embodiments, the qubit controllers can transmit the error syndromes to the regional decoders.

At step 1212, non-limiting method 1200 can comprise determining if there is an error detection event. If so (e.g., there is an error detection event), the non-limiting method 1200 can proceed to step 1128. If not (e.g., there is not an error detection event), the non-limiting method 1200 can proceed to step 1214.

At step 1214, non-limiting method 1200 can comprise transmitting (e.g., by execution component 114), logical frames to the qubit controllers, wherein the logical frames can comprise error correction instructions and transmitting the error syndromes to QEC controllers.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 13 illustrates a block diagram of an example, non-limiting, operating environment in which one or more embodiments described herein can be facilitated. FIG. 13 and the following discussion are intended to provide a general description of a suitable operating environment 1300 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as quantum error correction with regional decoders code 1326. In addition to block 1326, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1326, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1326 in persistent storage 1313.

COMMUNICATION FABRIC 1311 is the signal conduction paths that allow the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface type operating systems that employ a kernel. The code included in block 1326 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
map one or more regional decoders to one or more modules, wherein each of the one or more modules comprise one or more logical qubits, and wherein each of the one or more regional decoders operate on a region comprising one module and at least a subsection of another module; and
coordinate managing of the one or more regional decoders by facilitating logical operations between a first logical qubit and a second logical qubit.

2. The system of claim 1, wherein the logical operations comprise:
joining code of the first logical qubit to code of the second logical qubit if the first logical qubit and the second logical qubit are positioned within the same regional decoder.

3. The system of claim 1, wherein the logical operations further comprise:
teleporting the first logical qubit into the region operated on by a regional decoder comprising the second logical qubit and join code of the first logical qubit to code of the second logical qubit.

4. The system of claim 1, wherein the logical operations further comprise:
teleport the first logical qubit into the region operated on by the regional decoder comprising the first logical qubit and the second logical qubit.

5. The system of claim 1, wherein the logical operations are performed via lattice surgery, gauge fixing, code deformation, or code switching.

6. The system of claim 1, wherein the one or more modules are coupled together to form a graph topology of the quantum system, and wherein the one module is adjacent to the other module in the graph topology.

7. The system of claim 1, wherein the at least one of the computer executable components further:
obtain error syndromes of one or more physical qubits via respective qubit controllers, and wherein the one or more regional decoders transmit the error syndromes to respective quantum error correction (QEC) controllers.

8. The system of claim 5, wherein a global QEC controller distributes a QEC execution schedule to the respective QEC controllers, and wherein the respective QEC controllers transmit the error syndromes to the global QEC controller.

9. The system of claim 5, wherein the respective QEC controllers execute sub-schedules of a distributed QEC execution schedule that is shared between the respective QEC controllers, and wherein the respective QEC controllers transmit the error syndromes to other respective QEC controllers.

10. The system of claim 1, wherein the one or more regional decoders transmit logical frames to the respective qubit controllers.

11. The system of claim 5, wherein the respective QEC controllers trigger the respective qubit controllers via sequence triggers.

12. The system of claim 1, wherein the logical operations further comprise:
teleporting the first logical qubit or the second logical qubit to another subsection of a module operated on by a regional decoder.

13. A computer-implemented method, comprising:
mapping, by a system operatively coupled to a processor, one or more regional decoders to one or more modules, wherein each of the modules comprise one or more logical qubits, and wherein each of the one or more regional decoders operate on a region comprising one module and at least a subsection of another module; and
coordinating, by the system, managing of the one or more regional decoders by facilitating logical operations between a first logical qubit and a second logical qubit.

14. The computer-implemented method of claim 13, wherein the logical operations comprise:
joining code of the first logical qubit to code of the second logical qubit if the first logical qubit and the second logical qubit are positioned within the same region operated on by a regional decoder.

15. The computer-implemented method of claim 13, wherein the logical operations further comprise:
teleporting code of the first logical qubit into the region operated on by the regional decoder comprising the second logical qubit and joining code of the first logical qubit to code of the second logical qubit.

16. The computer-implemented method of claim 13, wherein the logical operations further comprise:
teleporting the first logical qubit into the region operated on by the regional decoder comprising the first logical qubit and the second logical qubit.

17. The computer-implemented method of claim 13, further comprising:
obtaining, by the system, error syndromes of one or more physical qubits via respective qubit controllers, and wherein the one or more regional decoders transmit the error syndromes to respective quantum error correction (QEC) controllers.

18. The computer-implemented method of claim 17, wherein a global QEC controller distributes a QEC execution schedule to the respective QEC controllers, and wherein the respective QEC controllers transmit the error syndromes to the global QEC controller.

19. A computer program product for regional decoders for quantum error correction, the computer program product comprising a computer readable storage medium having program instructions embodied therewith, the program instructions executable by a processor to cause the processor to:
map, by the processor, one or more regional decoders to one or more modules, wherein each of the one or more modules comprise one or more logical qubits, and wherein each of the one or more regional decoders operate on a region comprising one module and at least a subsection of another module; and
coordinate, by the processor, managing of the one or more regional decoders by facilitating logical operations between a first logical qubit and a second logical qubit.

20. The computer program product of claim 19, wherein the logical operations comprise:
joining code of the first logical qubit to code of the second logical qubit if the first logical qubit and the second logical qubit are positioned within the same region operated on by a regional decoder;
teleporting the first logical qubit into the region operated on by the regional decoder comprising the second logical qubit and joining code of the first logical qubit to code of the second logical qubit; or
teleporting the first logical qubit into the region operated on by the regional decoder comprising the first logical qubit and the second logical qubit.
